(19) United States
(12) Patent Application Publication
(10) Pub. No.: US 2019/0045794 A1
(43) Pub. Date: Feb. 14, 2019

(54) NATURAL HERBICIDE COMPOSITION AND METHOD FOR USING SAME

(71) Applicant: BA Organics LLC, Hardwick, NJ (US)

(72) Inventor: Marie Ciaffa, Hardwick, NJ (US)

(73) Assignee: BA Organics LLC, Hardwick, NJ (US)

(21) Appl. No.: 15/673,457

(22) Filed: Aug. 10, 2017

(51) Int. Cl. A01N 59/08; A01N 37/02; A01N 43/08

(52) U.S. Cl. CPC A01N 59/08; A01N 43/08; A01N 37/02

(57) ABSTRACT

A natural toxicologically-safe, in some embodiments, non-staining herbicide composition of, for example, acetic acid, sodium chloride, and citric acid, as the herbicidal active component, which may be in the form of an aqueous liquid. Also, a method for killing undesired weeds by contacting the undesired weeds with this natural toxicologically-safe, in some embodiments, non-staining herbicide composition.

### FIELD OF THE INVENTION

The present invention broadly relates to a natural toxicologically-safe (in some embodiments non-staining) herbicide composition comprising, for example, acetic acid, sodium chloride, and citric acid and/or ascorbic acid, as the herbicidal active component, which may be in the form of an aqueous liquid. The present invention also broadly relates to a method for killing weeds by contacting the undesired weeds with this natural toxicologically-safe (in some embodiments non-staining) herbicide composition.

### BACKGROUND

The use of herbicides to kill and control a broad spectrum of weeds is known. Chemical herbicides may be used for the purpose of weed control for ornamental and agricultural plants. Many herbicidal compositions exist which may be effective in killing all vegetation or selective vegetation. Control of weeds may be very beneficial when it permits the selective control of such plants without concurrent injury to other desirable vegetation. Many of these herbicidal compositions are based on sophisticated chemicals, some of which are toxic to other life forms such as humans, pets, etc.

Chemical herbicides may be classified according to the type of activity they possess. A given compound may have more than one type of herbicidal activity depending upon its mode of application and the rate at which it is applied. In addition, herbicides may be classified as selective or non-selective pre-emergent herbicides or post-emergent herbicides. An effective pre-emergence herbicide is one which may be selective, i.e., can kill the seed and germinated seedlings of undesirable plant(s) without harm to the seed and germinated seedlings of the desirable plant(s), and may also do so without also causing over penetration of the soil by the herbicide. By contrast, post-emergence herbicides may be applied after the plant and weed have reached a substantial height.

One of the oldest and possibly most successful selective herbicide is 2,4-dichlorophenoxy) acetic acid (commonly known as “2,4-D”) is a member of the phenoxy family of natural herbicides, which once was widely used as an organic natural herbicide. These phenoxy herbicides were effective and economical for selectively controlling broadleaf weeds in crops. Indeed, since around 1945, phenoxy herbicides have provided very economical, selective, post-emergence control of broadleaf weeds in crops and non-crop land. These phenoxy herbicides have been used with little or no apparent acute or chronic toxicity to humans or animals such as pets. Even so, naturalists and others may not be satisfied that there no apparent relationship between the use of phenoxy family of herbicides, specifically, 2-4 D, and the occurrence of diseases, aliments, etc. In particular, 2-4D may cause eye irritation and gastrointestinal problems if ingested in sufficient quantities by humans or animals such as pets. That may create concerns when contemplating the use of herbicides on vegetation that is to be consumed by humans or animals such as pets, or when applying herbicides to areas such as lawn or golf courses that are actively used by humans or animals such as pets.

In contrast to selective herbicides such as 2,4-D are non-selective herbicides. An example of a non-selective herbicide which has been used is N-(phosphonomethyl)glycine under the trademark/trade name “ROUNDUP.” In order to use such non-selective herbicides on crops (e.g., soybeans, etc.) which would otherwise be killed, such crops may need to be genetically altered (e.g., ROUNDUP-READY soybeans, etc.) to be resistant to such non-selective herbicides.

### SUMMARY

According to a first broad aspect of the present invention, there is provided a product which is in the form of a toxicologically-safe herbicidal composition, the herbicidal composition comprising:
an effective herbicidal amount of an herbicidal active component, the herbicidal active component having, by total weight thereof:
   from about 15 to about 25% w/w (exclusive of water) of one or more acetic acid compounds;
   from about 50 to about 70% w/w (exclusive of water) of one or more alkali metal chloride salts; and
   from about 9 to about 25% w/w (exclusive of water) of one or more hydroxyacid compounds selected from the group consisting of: citric acid compounds and ascorbic acid compounds.

According to a second broad aspect of the present invention, there is provided a product which is in the form of an aqueous liquid toxicologically-safe herbicidal composition, the herbicidal composition comprising:
an effective herbicidal amount of a herbicidal active component, the herbicidal active component having, by total weight thereof:
   from about 15 to about 25% w/w (exclusive of water) of one or more acetic acid compounds;
   from about 50 to about 70% w/w (exclusive of water) of one or more alkali metal chloride salts; and
   from about 9 to about 25% w/w (exclusive of water) of one or more hydroxyacid compounds selected from the group consisting of: citric acid compounds and ascorbic acid compounds;
the balance being water.

According to a third broad aspect of the present invention, there is provided a method for killing weeds, the method comprising the following steps:
(a) providing an aqueous liquid toxicologically-safe herbicidal composition, the herbicidal composition comprising: an effective herbicidal amount of a herbicidal active component, the herbicidal active component having, by total weight thereof:
   from about 15 to about 25% w/w (exclusive of water) of one or more acetic acid compounds;
   from about 50 to about 70% w/w (exclusive of water) of one or more alkali metal chloride salts; and
   from about 9 to about 25% w/w (exclusive of water) of one or more hydroxyacid compounds selected from the group consisting of: citric acid compounds and ascorbic acid compounds;
the balance being water; and
(b) contacting the weeds with an effective herbicidal amount of the herbicidal composition of step (a).

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “herbicidal composition” refers to those compositions which are effective as herbicides. Embodiments of the herbicidal compositions of the present invention may be formulated as concentrates comprising the various ingredients in the desired amounts and weight ratios which may be dissolved in water, may be diluted to the desired concentration, strength, etc., for use, may be formulated as single-strength “ready-to-use” compositions, etc.

For the purposes of the present invention, the term “herbicide” (also referred to interchangeably herein as “weed killer”) refers to those compositions, compounds, components, ingredients, materials, etc., which are effective to kill, remove, destroy, defoliate, exterminate, eradicate, eliminate, etc., weeds, as well as to retard, regulate, inhibit, prevent, etc., the growth of such weeds.

For the purposes of the present invention, the term “weed” refers to the common meaning of the term as any herbaceous plant, vegetation, foliage, grasses, etc., which is deemed to be undesirable or undesired, for example, as encumbering the ground, as hindering, stifling, overwhelming, etc., the growth of what is deemed desired or more desirable plant, vegetation, foliage, grasses, etc. Weeds for which the herbicidal compositions are effective against may include one or more of: broadleaf weeds such as dandelions, clover, plantain, chickweed, undesired grasses, moss, other common weeds, etc.

For the purposes of the present invention, the terms “natural” and “naturally” refers to those herbicidal compositions which comprise compounds, components, ingredients, materials, etc., which may be obtained without being chemically synthesized, and which are toxicologically safe. Such natural compounds, components, ingredients, materials may include the herbicidal active components of the embodiments of the herbicidal compositions such as acetic acid, sodium chloride, citric acid, etc., as well as other optional compounds, components, ingredients, materials, etc., such as malic acid, surfactants, etc.

For the purposes of the present invention, the term “non-staining” refers to those embodiments of the herbicidal composition of the present invention which may impart minimal to no discoloration to outdoor surfaces such as slate, concrete, asphalt, pavers, stone, wood and/or metal walkways, etc., when applied in contacting, treating, etc., weeds. For example, these non-staining embodiments would exclude compounds, components, ingredients, materials, etc., such as ascorbic acid, malic acid, etc., which may cause staining of such surfaces, but which may be included in other embodiments of the herbicidal composition of the present invention where staining of such surfaces is not a concern, issue, problem, etc. In some instances, these non-staining embodiments may impart a slight non-staining residue, film, etc. which may remain after the applied herbicide composition has dried and which may be easily removed after being rinsed, washed, soaked, etc., for example, with water, rain, other aqueous liquids, etc.

For the purposes of the present invention, the term “toxicologically safe,” when used in reference to those embodiments of the herbicidal compositions, formulations, etc., of the present invention, as well as their respective compounds, components, ingredients, materials, etc., refers to the conventional sense of this term (e.g., Generally Recognized as Safe (GRAS), etc.) of being safe for use, contact, etc., with humans, animals, etc., e.g., do not exhibit toxic, dermatological, etc., side effects when in contact with, on, etc., humans, animals.

For the purposes of the present invention, the term “herbicidal active component” refers to those compounds, components, ingredients, materials, etc., alone or in combination which are effective to kill, remove, destroy, defoliate, exterminate, eradicate, eliminate, etc., the desired weeds. Compounds, components, ingredients, materials, etc., which may comprise the herbicidal active component include: acetic acid compounds, alkali metal chloride salts, and hydroxyacid compounds, as well as optionally calcium chloride, bicarbonate of soda (sodium bicarbonate), Epsom salts, malic acid, magnesium chloride, etc.

For the purposes of the present invention, the term “effective herbicidal amount” refers to an amount of the herbicidal composition, and especially the herbicidal active component thereof, which is effective to noticeably kill, remove, destroy, defoliate, exterminate, eradicate, eliminate, etc., weeds when those weeds are contacted with herbicidal composition. For example, the herbicidal active component may comprise at least about 5% w/w, such as from about 5 to 40 w/w % (e.g., from about 15 to 25 w/w %) of the herbicidal composition, including any water which may be present in the herbicidal composition. In general, embodiments of the herbicidal composition of the present invention provide an effective herbicidal action when, for example, applied to the weed-infested area in amounts sufficient to thoroughly coat the weeds up to the point of the herbicidal composition running-off.

For the purposes of the present invention, the term “non-selective” refers to herbicidal compositions which are not selective in terms which weeds the composition are effective to kill, remove, destroy, defoliate, exterminate, eradicate, eliminate, etc., in contrast to those herbicidal compositions which are selective as to certain weeds, for example, 2,4-dichlorophenoxy) acetic acid (commonly known as “2,4-D”) which is selective in killing, removing, destroying, defoliating, exterminating, eradicating, eliminating, etc., broadleaf weeds. The embodiments of the herbicidal compositions of the present invention are normally non-selective in terms of weed that such compositions may kill, remove, destroy, defoliate, exterminate, eradicate, eliminate, etc.

For the purposes of the present invention, the term “acetic acid compound” refers to acetic acid (i.e., the chemical having the formula CH₃COOH), water-soluble salts of acetic acid such as sodium acetate, potassium acetate, etc., as well as mixtures thereof. Acetic acid may be produced by bacterial fermentation of ethanol, fermentation of sugar-containing (e.g., sucrose, fructose, glucose, etc.) mixtures such as apple juice, grape juice, etc., but may also be produced synthetically. Acetic acid may be in the form of domestic white vinegar, distilled white vinegar, glacial acetic acid, apple cider vinegar, red wine vinegar, as well as any other vinegar used in the food or commercial industry, etc. Sources of acetic acid as used in embodiments of the herbicidal compositions of the present may be obtained from or as 5% to 8% acetic acid solutions, as a diluted aqueous solution of acetic acid such as from distilled vinegar, as acetic acid in solid form (e.g., granular, powder, etc.) which may be dissolved, dispersed, etc., in an aqueous liquid (e.g., water, vinegar, etc.), etc.

For the purposes of the present invention, the term “alkali metal chloride salt” refers to water-soluble chloride salts of sodium (i.e., sodium chloride, also referred to interchangeably herein as “common salt”), potassium chloride, etc., as well as mixtures of such salts.

For the purposes of the present invention, the term “hydroxyacid compound” refers to citric acid, ascorbic acid, as well as the water-soluble salts of these acids. Other than in terms of its staining properties, in embodiments of the herbicidal compositions of the present invention, ascorbic acid (and its respective water soluble salts) is functionally partially or wholly substitutable for citric acid (and its respective water soluble salts) in the herbicidal active component.

For the purposes of the present invention, the term “citric acid compound” refers to citric acid, water-soluble salts of citric acid, such as, for example, sodium citrate, potassium citrate, trisodium citrate, monosodium citrate, monocalcium citrate, magnesium citrate, disodium citrate, dicalcium citrate, calcium citrate malate, etc., as well as mixtures thereof. Citric acid may be provided by citrus juice, such as lemon juice or citrus juice obtained from other citrus fruits, such as lime, orange, grapefruit, pineapple, tangerines, etc.

For the purposes of the present invention, the term “ascorbic acid compound” refers to ascorbic acid (also referred to interchangeably as “vitamin C”), water-soluble salts of ascorbic acid, such as, for example, sodium ascorbate, potassium ascorbate, calcium ascorbate, magnesium ascorbate, etc., as well as mixtures thereof. Like citric acid, ascorbic acid may be provided by citrus juice, such as lemon juice or citrus juice obtained from other citrus fruits, such as lime, orange, grapefruit, pineapple, tangerines, etc.

For the purposes of the present invention, the term “aqueous liquid” refers to those compositions, formulations, etc., which are liquid and which comprise measurable amount of water.

For the purposes of the present invention, the term “% w/w” refers to the weight percentage of each compound, ingredient, material, etc. (e.g., acetic acid compound, alkali metal chloride salt, hydroxyacid compound, etc.), relative to the total weight of the component (e.g., herbicidal active component), composition, formulation, etc., including the weight amount contributed by any water that may be present in the component, composition, formulation, etc.

For the purposes of the present invention, the term “% w/w (exclusive of water)” refers to the weight percentage of each compound, ingredient, material, etc. (e.g., acetic acid compound, alkali metal chloride salt, hydroxyacid compound, etc.), relative to the total weight of the component (e.g., herbicidal active component), composition, formulation, etc., excluding any weight amount which may contributed by any water that may be present in the component, composition, formulation, etc. (e.g., only the amounts of the liquid and/or solid components which are not water such as the acetic acid compound, the alkali metal chloride salt, the hydroxyacid compound, etc., are reflected in such total weights).

For the purposes of the present invention, the term “the balance being water” refers to the conventional sense of that term such that, with respect to those compositions, formulations, etc., which may comprise some measurable amount of water, whatever weight percentage remains that is required to achieve a composition, formulation, etc., having 100% total weight of ingredients (i.e., the total ingredients are 100% w/w), whatever remaining percentage is required represents water (i.e., water provides the balance of the composition, formula, etc.).

For purposes of the present invention, the term “contacting” refers to treating, applying, spraying, wetting, soaking, dousing, dipping, immersing, sprinkling, wiping, daubing, spreading, splattering, smearing, etc., any weeds, portions of weeds, etc., desired to be killed, removed, destroyed, defoliated, exterminated, eradicated, eliminated, etc., with an embodiment of the herbicidal composition present invention.

For the purposes of the present invention, the term “liquid” refers to compositions, formulations, etc., which are liquid (i.e., not solid) at room temperature.

For the purposes of the present invention, the term “solid” refers to compositions, formulations, etc., which are solid (i.e., not liquid) at room temperature.

For the purposes of the present invention, the term “room temperature” refers to the commonly accepted meaning of room temperature, i.e., an ambient temperature of 20° to 25° C.

For the purposes of the present invention, the term “comprising” means various compositions, compounds, components, elements, steps, etc., may be conjointly employed in embodiments of the present invention. Accordingly, the term “comprising” encompasses the more restrictive terms “consisting essentially of” and “consisting of” For example, the term “consisting essentially of” may be used with reference to some non-staining embodiments of the herbicidal compositions of the present invention to exclude those compounds, components, ingredients, materials, etc., such as ascorbic acid, malic acid, etc., which may cause staining of outdoor surfaces.

For the purposes of the present invention, the terms “a” and “an” and similar phrases are to be interpreted as “at least one” and “one or more.” References to “an” embodiment in this disclosure are not necessarily to the same embodiment.

For the purposes of the present invention, the term “and/or” means that one or more of the various compositions, compounds, components, elements, steps, etc., may be employed in embodiments of the present invention.

Unless otherwise specified, all percentages given herein are by weight (i.e., % w/w).

### DESCRIPTION

Recently due to various environmental considerations, many herbicides such as 2,4-D, have been criticized as being chemical pollutants, including arguments that their negative impact on the environment far outweighs any advantages that may be realized by their use. In addition, many municipalities and towns may have limited or even banned the use of synthetic herbicidal compounds, compositions, etc. Even so, the general public, municipalities, government public works departments, utilities, etc., remain active in looking for effective alternatives, replacements, etc., to such herbicidal compounds, compositions, etc., in order to control undesired weeds to keep lawns, flower beds, etc., neat-looking and attractive.

Prior herbicidal compositions, including those characterized as being “natural” or “organic” weed killers may also require labels with extensive warnings, may contain natural ingredients such as cinnamon oil, clove oil, citrus oil or a very high level of vinegar (e.g., providing a level of acetic acid above about 8%) that is caustic. Others herbicidal compositions may contain iron which may stain outdoor surfaces if the herbicidal composition is used on driveways, patios, sidewalks, walkways, etc. In addition to numerous medical warnings, labels for prior herbicidal compositions may also instruct the user to wear combinations of the following items for safe use thereof: goggles, gloves, long sleeved shirts. Accordingly, there remains a need for a safe, non-staining, natural weed killer composition requiring minimal warning (e.g., on labels) for use.

Embodiments of the herbicidal compositions of the present invention may be formulated to be toxicologically-safe for use, may be formulated from compounds, ingredients, materials, etc., which have not been chemically synthesized, etc., yet are effective to kill, remove, destroy, defoliate, exterminate, eradicate, eliminate, etc., weeds such as broadleaf weeds (e.g., dandelions, clover, plantain, chickweed etc.), undesired grasses, moss, other common weeds, etc. These toxicologically-safe herbicidal compositions may comprise an effective herbicidal amount of a herbicidal active component and may be in the form of an aqueous liquid. The herbicidal active component may include, by total weight of the herbicidal active component (exclusive of water): from about 15 to about 25% w/w (such as from about 16 to about 19% w/w) of one or more acetic acid compounds, such as acetic acid, as well as sources of acetic such as domestic white vinegar, distilled white vinegar, glacial acetic acid, apple cider vinegar, red wine vinegar, other vinegars used in the food or commercial industry, etc.; from about 50 to about 70% w/w (such as from about 55 to about 65% w/w) of one or more alkali metal chloride salts, such as sodium chloride, potassium chloride, etc.; and from about 9 to about 25% w/w (such as from about 19 to about 23% w/w) of one or more hydroxyacid compounds selected from citric acid compounds, such as citric acid, sodium citrate, potassium citrate, trisodium citrate, monosodium citrate, monocalcium citrate, magnesium citrate, disodium citrate, dicalcium citrate, calcium citrate malate, etc., and/or ascorbic acid compounds, such as ascorbic acid, sodium ascorbate, potassium ascorbate, calcium ascorbate, magnesium ascorbate, etc. Other optional compounds, ingredients, materials, etc., which may be present in embodiments of herbicidal compositions for the present invention may include one or more of the following additives to provide one or more of surfactant, desiccant, etc., properties: malic acid, gum arabic, Yucca extract, lecithin, corn gluten, etc. For embodiments of herbicidal compositions for the present invention in the form of aqueous liquids, the balance of the composition comprises water. Some embodiments of these herbicidal compositions may also be formulated to be non-staining by excluding, for example, certain compounds, components, ingredients, materials, which may be present in some embodiments of these herbicidal compositions, such as ascorbic acid, malic acid, etc., which may cause staining of such surfaces.

Embodiments of the method for killing weeds of the present invention may comprise the following steps: (1) providing an aqueous liquid toxicologically-safe, non-staining herbicidal composition (as described above); and (2) contacting the weeds with an effective herbicidal amount of the herbicidal composition. For example, this herbicidal composition may be applied (e.g., by spraying as an aqueous liquid) onto areas infested with weeds in amounts which provide in the range of from about 0.1 to about 15 g./ft², such as from about 0.18 to about 10.8 g./ft², of the herbicidal active component. When applied for example, by a spray pump in aqueous liquid form, amounts in the range of from about 0.5 to about 40 ml./ft², such as from about 0.9 to about 36 ml./ft², may also be suitable. In order to use embodiments of the herbicidal composition of the present invention, the user may, for example, simply add an appropriate amount of water (or in some embodiments, aqueous solutions of acetic acid, such as distilled vinegar to provide part or all of the herbicidal acetic acid) to a spray bottle containing the ingredients forming the herbicidal active component (e.g., acetic acid, sodium chloride, citric acid and/or ascorbic acid, etc.), shake the spray bottle to mix and dissolve the ingredients in the added water to form an aqueous solution thereof, and then apply the mixed aqueous solution to weed infested area in an appropriate effective herbicidal amount, as described above. For stubborn weeds, the aqueous solution of the herbicidal composition may be repeatedly applied as may be necessary to achieve desired weed control. Embodiments of the herbicidal composition of the present invention may be particularly effective when applied to younger emerging weeds (e.g., weeds appearing within a week or so). Embodiments of the herbicidal composition of the present invention may also be particularly effective when applied to the weeds until those weeds are thoroughly coated with the herbicidal composition (e.g., up to the point of run-off) and then allowed to dry for upwards of a day (e.g., up to about 24 hours) and when under full sun for maximum weed killing effect. Embodiments of the herbicidal composition of the present invention may also be applied, for example, anytime from spring through fall to achieve desirable effects in terms of killing, removing, eradicating, etc., undesirable weeds.

The use of the embodiments of the herbicidal composition of the present invention may provide many different benefits, advantages, etc. For example, the embodiments of these herbicidal compositions may act as a contact herbicide, may be applied by spraying above-ground portions of the weeds that are desired to be killed, removed, destroyed, defoliated, exterminated, eradicated, eliminated, etc. The herbicidal activity of the acetic acid compound(s) (e.g., acetic acid) and the alkali metal chloride salt(s) (e.g., sodium chloride) in the herbicidal active component of the embodiments of the herbicidal composition of the present invention are enhanced by the inclusion of one or more hydroxy acid compounds selected form citric acid compounds (e.g., citric acid) and/or ascorbic acid compounds (e.g., ascorbic acid) to help, assist, etc., the herbicidal composition, especially in liquid form, to adhere to the leaves, to suspend these other herbicidal active components (e.g., powdered acetic acid sodium chloride, etc.) when water is added, etc., citric acid compounds (e.g., citric acid) being especially desirable for this function where staining of outdoor surfaces needs to be minimized or avoided. Wetting agents (also referred to interchangeably herein as “surfactants”), which may include edible emulsifiers such as lecithin, Yucca extract, corn gluten, etc., may be included to enhance the wetting ability of these herbicidal compositions on the vegetative growth (e.g., weeds) to which the herbicidal composition in aqueous liquid form is applied, sprayed, etc. Where uses of the embodiments of the herbicidal composition of the present invention may include exposure to higher temperatures (e.g., about 80° F. or higher), it may be desirable to retard, inhibit, impede, etc., evaporation of the aqueous liquid form of these herbicidal compositions by incorporating therein, for example, a suitable amount of a natural or organic oil(s), such as olive oil, grape seed oil, vegetable oil, palm oil, corn oil, canola oil, peanut oil, sesame oil, mineral oil, etc., so that the herbicidal composition may be in the form of an emulsion. Such emulsion forms of these herbicidal compositions may then be spread, for example, on the vegetative growth (e.g., weeds) to be killed, removed, destroyed, defoliated, exterminated, eradicated, eliminated, etc. Some non-staining embodiments of the herbicidal compositions of the present invention may also be used, for example, to control weeds on or adjacent to sidewalks, patios, walkways, driveways, etc, without staining such outer surfaces, and which are safe for use around children, pets, etc.

Embodiments of the herbicidal compositions of the present invention may be prepared, for example, from dry ingredients (e.g., dry powdered acetic acid, sodium chloride/common salt, powdered citric acid and/or ascorbic acid, etc.) which may be mixed with water or other aqueous liquid, from some dry ingredients (e.g., sodium chloride/common salt, powdered citric acid and/or ascorbic acid, etc.) mixed partially or wholly with a liquid form of acetic acid (e.g., distilled vinegar), etc. For example, the user may simply add water to a spray bottle containing the herbicidal active component (e.g., acetic acid compound, alkali metal chloride salt, citric acid compound and/or ascorbic acid compound), plus any other optional compounds, ingredients, materials, etc., such as malic acid, sodium acetate (which may function as a desiccant), wetting agents/surfactants/emulsifiers (e.g., lecithin, Yucca extract, corn gluten, etc.), then shaken in a spray bottle to mix and dissolve the contents thereof for use. While acetic acid and sodium chloride are the primary active herbicidal ingredients, citric acid (for non-staining formulations) and/or ascorbic acid (for formulations where staining of outdoor surfaces is not an issue or problem) function by helping the liquid herbicidal composition adhere to the leaves and to suspend these other primary herbicidal active ingredients, such as the sodium chloride and powdered acetic acid, when water is added.

Exemplary formulations of the herbicidal compositions of the present invention may be prepared to have herbicidal active components comprising the following compounds, ingredients, materials, etc., in the following amounts: acetic acid in amounts in the range of from about 25 to about 50 g. (such as from about 30 to about 40 g.); sodium chloride in amounts in the range of from about 75 to about 200 g. (such as from about 110 to about 120 g.); citric acid in amounts of from about 10 to about 60 g. (such as from about 40 to about 50 g.); and ascorbic acid (partially or wholly in place of citric acid) in amounts in the range of from about 14 to about 60 g. (such as from about 40 to about 50 g.). These exemplary formulations of these herbicidal compositions of the present invention may also be prepared to have the following optional compounds, ingredients, materials, etc., in the following amounts: malic acid in amounts in the range of from about 0.5 to about 10 g. (such as from about 1 to about 1.5 g.); sodium citrate in amounts in the range of from about 7 to about 80 g. (such as from about 30 to about 40 g.).

Exemplary formulations of the herbicidal compositions of the present invention may also be prepared to have the following weight ratios of the indicated compounds, ingredients, materials, etc.: a weight ratio of acetic acid to sodium chloride in the range of from about 1:1.6 to about 1:4. (such as from about 1:2.3 to about 1:2.5); a weight ratio of acetic acid to citric acid in the range of from about 3.4:1 to about 1:1.25 (such as from about 1.2:1 to about 1:1.04); a weight ratio of acetic acid to ascorbic acid in the range of from about 3.4:1 to about 1:1.25 (such as from about 1.2:1 to about 1:1.04); a weight ratio of acetic acid to malic acid in the range of from about 96:1 to about 4.8:1 (such as from about 48:1 to about 32:1); and a weight ratio of acetic acid to sodium citrate in the range of from about 6.9:1 to about 1:1.7 (such as from about 1.6:1 to about 1.2:1).

### EXAMPLES

Illustrative examples of embodiments of the herbicidal compositions of the present invention, are shown below:

### Example 1

The ingredients and amounts of an illustrative herbicidal composition (in the form of an aqueous liquid) according to an embodiment of the present invention is shown in the following Table 1:

TABLE 1

| COMPONENT | AMOUNT | AMOUNT (w/w)² |
|---|---|---|
| Acetic acid¹ | 31 g. | 16.49% |
| Sodium chloride | 115 g. | 61.17% |
| Citric acid | 42 g. | 22.34% |
| Water¹ | 569 g. | — |
| TOTAL | 757 g. | — |

¹from distilled white vinegar containing 5% acetic acid
²relative to total amount of acetic acid, sodium chloride, and citric acid (188 g.) only.

The herbicidal composition is formulated by mixing and shaking together the distilled white vinegar containing 5% acetic acid, sodium chloride, and citric acid in a spray bottle.

### Example 2

The ingredients and amounts of an illustrative herbicidal composition (in the form of an aqueous liquid) according to another embodiment of the present invention is shown in the following Table 2:

TABLE 2

| COMPONENT | AMOUNT | AMOUNT (w/w)² |
|---|---|---|
| Acetic acid¹ | 31 g. | 16.49% |
| Sodium chloride | 115 g. | 61.17% |
| Citric acid | 21 g. | 11.17% |
| Ascorbic acid | 21 g. | 11.17% |
| Water¹ | 569 g. | — |
| TOTAL | 757 g. | — |

¹from distilled white vinegar containing 5% acetic acid
²relative to total amount of acetic acid, sodium chloride, and ascorbic acid (188 g.) only

The herbicidal composition is formulated by mixing and shaking together the distilled white vinegar containing 5% acetic acid, sodium chloride, citric acid, and water in a spray bottle similar to Example 1.

### Example 3

The ingredients and amounts of an illustrative herbicidal composition (in the form of an aqueous liquid) according to yet another embodiment of the present invention is shown in the following Table 3:

TABLE 3

| COMPONENT | AMOUNT | | AMOUNT (w/w)² |
|---|---|---|---|
| Acetic acid¹ | 31 | g. | 16.44% |
| Sodium chloride | 115 | g. | 61.13% |
| Citric acid | 42 | g. | 22.30% |
| Malic acid | 1 | gram | 0.13% |
| Water¹ | 569 | g. | — |
| TOTAL | 758 | g. | — |

¹from distilled white vinegar containing 5% acetic acid
²relative to total amount of acetic acid, sodium chloride, citric acid and malic acid (189 g.) only

The herbicidal composition is formulated by mixing and shaking together the distilled white vinegar containing 5% acetic acid, sodium chloride, citric acid, malic acid, and water in a spray bottle similar to Example 1.

All documents, patents, journal articles and other materials cited in the present application are hereby incorporated by reference.

Although the present invention has been fully described in conjunction with several embodiments thereof, it is to be understood that various changes and modifications may be apparent to those skilled in the art. Such changes and modifications are to be understood as included within the scope of the present invention as defined by the appended claims, unless they depart therefrom.

In addition, the purpose of the Abstract of the Disclosure in this application is to enable the U.S. Patent and Trademark Office, as well as the public generally, including any scientists, engineers and practitioners in the art who may not be familiar with patent or other legal terms or phraseology to determine the what the technical disclosure of the application describes. Accordingly, while the Abstract of the Disclosure may be used to provide enablement for the following claims, it is not intended to be limiting as to the scope of those claims in any way.

Finally, it is the applicant's intent that only claims which include the express language “means for” or “step for” be interpreted under 35 U.S.C. § 112, paragraph 6. Accordingly, claims that do not expressly include the phrase “means for” or “step for” are not to be interpreted as being within the purview of 35 U.S.C. § 112, paragraph 6, or to be construed as being subject to any case law interpreting the meaning of these phrases.

What is claimed is:

1. A product which is in the form of a toxicologically-safe herbicidal composition, the herbicidal composition comprising:
an effective herbicidal amount of a herbicidal active component, the herbicidal active component having, by weight thereof:
from about 15 to about 25% w/w of one or more acetic acid compounds;
from about 50 to about 70% w/w of one or more alkali metal chloride salts; and
from about 9 to about 25% w/w of one or more hydroxyacid compounds selected from the group consisting of: citric acid compounds and ascorbic acid compounds.

2. The product of claim 1, wherein the acetic acid compounds are one or more of: acetic acid; sodium acetate; or potassium acetate.

3. The product of claim 1, wherein the alkali metal chloride salts are one or more of: sodium chloride; or potassium chloride

4. The product of claim 1, wherein the one or more hydroxyacid compounds are selected from the group consisting of: citric acid; sodium citrate; potassium citrate; trisodium citrate; monosodium citrate; monocalcium citrate; magnesium citrate; disodium citrate; dicalcium citrate; and calcium citrate malate

5. The product of claim 1, wherein the one or more hydroxyacid compounds are selected from the group consisting of: ascorbic acid, sodium ascorbate, potassium ascorbate, calcium ascorbate, and magnesium ascorbate.

6. The product of claim 1, wherein the one or more acetic acid compounds are acetic acid, the one or more alkali metal chloride salts are sodium chloride, and the one or more hydroxyacid compounds are selected from the group consisting of citric acid compounds and ascorbic acid compounds.

7. The product of claim 6, wherein herbicidal active component has: from about 16 to about 19% w/w of acetic acid; from about 55 to about 65% w/w of sodium chloride; and from about 19 to about 23% w/w of citric acid.

8. The product of claim 6, wherein herbicidal composition has: from about 25 to about 50 g. of acetic acid; from about 75 to about 200 g. of sodium chloride; and from about 10 to about 60 g. of citric acid.

9. The product of claim 8, wherein herbicidal composition has: from about 30 to about 40 g. of acetic acid; from about 110 to about 120 g. of sodium chloride; and from about 40 to about 50 g. of citric acid.

10. The product of claim 6, wherein the one or more hydroxy acids is ascorbic acid in an amount of from about 14 to about 60 g.

11. The product claim 10, wherein the ascorbic acid is in an amount of from about 40 to about 50 g.

12. The product of claim 1, wherein the herbicidal composition is non-staining and consists essentially of the herbicidal active component.

13. The product of claim 1, wherein the herbicidal composition comprises from about 5 to 40% w/w of the herbicidal active component.

14. The product of claim 13, wherein the herbicidal composition comprises from about 15 to 100% w/w of the herbicidal active component.

15. The product of claim 1, wherein the herbicidal active component comprises acetic acid, sodium chloride, and citric acid in a weight ratio of acetic acid to sodium chloride in the range of from about 1:1.6 to about 1:4, a weight ratio of acetic acid to citric acid in the range of from about 3.4:1 to about 1:1.25.

16. The product of claim 15, further comprising: ascorbic acid in a weight ratio of acetic acid to ascorbic acid in the range of from about 3.4:1 to about 1:1.25; and malic acid in a weight ratio of acetic acid to malic acid in the range of from about 96:1 to about 4.8:1.

17. The product of claim 16, wherein the weight ratio of acetic acid to sodium chloride is in the range of from about 1:2.3 to about 1:2.5, the weight ratio of acetic acid to citric acid is in the range of as from about 1.2:1 to about 1:1.04, the weight ratio of acetic acid to ascorbic acid is in the range of from about 1.2:1 to about 1:1.04, and the weight ratio of acetic acid to malic acid is in the range of from about 48:1 to about 32:1.

18. A product which is in the form of an aqueous liquid toxicologically-safe herbicidal composition, the herbicidal composition comprising:
an effective herbicidal amount of a herbicidal active component, the herbicidal active component having, by weight thereof:
from about 15 to about 25% w/w of one or more acetic acid compounds;
from about 50 to about 70% w/w of one or more alkali metal chloride salts; and
from about 9 to about 25% w/w of one or more hydroxyacid compounds selected from the group consisting of: citric acid compounds;
the balance being water.

19. The product of claim 18, wherein the herbicidal composition comprises from about 5 to 40 w/w % herbicidal active component.

20. The product of claim 19, wherein the herbicidal composition comprises from about 15 to about 25 w/w % herbicidal active component.

21. The product of claim 19, wherein the one or more acetic acid compounds are acetic acid, the one or more alkali metal chloride salts are sodium chloride, and the one or more hydroxy acid compounds are citric acid.

22. The product of claim 21, wherein herbicidal composition has: from about 25 to about 50 g. of acetic acid; from about 75 to about 200 g. of sodium chloride; and from about 10 to about 60 g. of citric acid.

23. The product of claim 22, wherein herbicidal composition has: from about 30 to about 40 g. of acetic acid; from about 110 to about 120 g. of sodium chloride; and from about 40 to about 50 g. of citric acid.

24. The product of claim 18, wherein the herbicidal composition is non-staining and consists essentially of the herbicidal active component and water.

25. A method for killing weeds, the method comprising the following steps:
(a) providing an aqueous liquid toxicologically-safe herbicidal composition, the herbicidal composition comprising: an effective herbicidal amount of an herbicidal active component, the herbicidal active component having, by weight thereof:
from about 15 to about 25% w/w of one or more acetic acid compounds;
from about 50 to about 70% w/w of one or more alkali metal chloride salts; and
from about 9 to about 25% w/w of one or more hydroxyacid acid compounds selected from the group consisting of: citric acid compounds and ascorbic acid compounds;
the balance being water; and
(b) contacting the weeds with an effective herbicidal amount of the herbicidal composition of step (a).

26. The method of claim 25, wherein step (b) is carried out by spraying the herbicidal composition of step (a) on the weeds in an amount which provides from about 0.1 to about 15 g./ft² of the herbicidal active component.

27. The method of claim 25, wherein step (b) is carried out by spraying the herbicidal composition of step (a) on the weeds in an amount which provides from about 0.18 to about 10.8 g./ft² of the herbicidal active component.

28. The method of claim 25, wherein the herbicidal composition of step (a) comprises from about 25 to about 50 g. of acetic acid; from about 75 to about 200 g. of sodium chloride; and from about 10 to about 60 g. of citric acid.
